(19) United States
(12) Patent Application Publication
(10) Pub. No.: US 2015/0349591 A1
(43) Pub. Date: Dec. 3, 2015

(54) Axial Gap Polyphase Motor, Stator for Use Therein, and Method for Producing Stator

(71) Applicant: Hitachi, Ltd., Chiyoda-ku, Tokyo (JP)

(72) Inventors: Kenta DEGUCHI, Tokyo (JP); Yuji ENOMOTO, Tokyo (JP); Hirooki TOKOI, Tokyo (JP)

(21) Appl. No.: 14/649,786

(22) PCT Filed: Nov. 18, 2013
(86) PCT No.: PCT/JP2013/080971

§ 371 Date: Jun. 4, 2015

(30) Foreign Application Priority Data
Dec. 7, 2012 (JP) 2012-268163

(51) Int. Cl. H02K 1/18; H02K 15/02; H02K 21/24

(52) U.S. Cl. CPC H02K 1/182; H02K 21/24; H02K 15/022

(57) ABSTRACT

There is provided an axial gap polyphase motor whereby losses caused by eddy currents generated in a stator core can be eliminated, while the stator core can be prevented from shifting out of position. The stator for use in the axial gap polyphase motor is provided with a layered stator core 1A having a plurality of core portions 2 arranged at equal spacing in the circumferential direction and protruding in the axial direction, and a plurality of supporting portions connecting and supporting the adjacent core portions 2, coils wound onto the core portions 2, and fastening members 4 made of conductive material. Only the core portions 2 onto which are wound the coils for flow of electric current of a single phase from among the multiple phases have first apertures 2H in the radial direction. The fastening members 4 are inserted into the first apertures 2H.

### TECHNICAL FIELD

The present invention relates to an axial gap rotor. More specifically, the present invention relates to a two-rotor-one-stator axial gap polyphase motor.

### BACKGROUND ART

Generally, rotation magnetic fields which are generated at driving a motor generate eddy currents in a stator core, thereby causing losses. Consequently, the stator core is typically formed by layering a magnetic thin plate whose surface is subjected to insulation coating. This electrically insulates the stator core in the layering direction, thereby eliminating the eddy currents generated in the stator core.

A technique for producing the stator core of an axial gap polyphase motor by spirally winding a magnetic thin plate whose surface is subjected to insulation coating has been known. For instance, proposed is a technique for producing a layered stator core by spirally winding a magnetic thin plate formed with cutouts and by integrally forming supporting portions continuous in the circumferential direction and core portions protruding in the axial direction (for instance, see Patent Literature 1). In the conventional example, the stator core of the respective phases is fixed by inserting fastening members thereinto in the radial direction.

In addition, a technique for fixing a stator core of the respective phases by winding a belt-like electromagnetic steel plate into a roll and by inserting fastening members thereinto in the radial direction (for instance, see Patent Literature 2).

### CITATION LIST

### Patent Literature

Patent Literature 1: Japanese Unexamined Patent Application Publication No. Sho 53-114003

Patent Literature 2: Japanese Unexamined Patent Application Publication No. 2004-357391

### SUMMARY OF INVENTION

### Technical Problem

The structures proposed in Patent Literatures 1 and 2 can fix the stator core by preventing the layers thereof from shifting out of position.

However, in the techniques disclosed in Patent Literatures 1 and 2, the fastening members inserted into the stator core of the respective phases allow it to be electrically conductive in the radial direction. Consequently, when rotation magnetic fields act on the stator core, eddy current loops are generated through the magnetic thin plate of the respective phases and the fastening members, resulting in increasing losses.

An object of the present invention is to provide an axial gap polyphase motor whereby losses caused by eddy currents generated in a stator core can be eliminated, while the stator core can be prevented from shifting out of position, a stator for use therein, and a method for producing the stator.

### Solution to Problem

To achieve the above object, the present invention provides an axial gap polyphase motor including a layered stator core having a plurality of core portions arranged at equal spacing in the circumferential direction and protruding to both sides in the axial direction, and a plurality of supporting portions connecting and supporting the adjacent core portions, coils wound onto the core portions, and bar-like fastening members made of conductive material, in which only the core portions onto which are wound the coils for flow of electric current of a single phase from among the multiple phases or the supporting portions connecting and supporting the core portions and the next core portions onto which are wound the coils for flow of electric current of the next phase have first apertures in the radial direction, in which the fastening members are inserted into the first apertures.

### Advantageous Effects of Invention

According to the present invention, losses caused by eddy current generated in the stator core can be eliminated, while the stator core can be prevented from shifting out of position. Other problems, structures, and effects will be apparent from the description of the following embodiments.

### BRIEF DESCRIPTION OF DRAWINGS

FIG. 1 is a perspective view (schematic diagram) of an axial gap three-phase motor according to a first embodiment of the present invention.

FIG. 2 is a cross-sectional view of the axial gap three-phase motor according to the first embodiment of the present invention.

FIG. 3 is a block diagram (perspective view) of a layered stator core for use in the axial gap three-phase motor according to the first embodiment of the present invention.

FIG. 4 is a cross-sectional view (perspective view) of the layered stator core illustrated in FIG. 3 taken along the center in the axial-direction (y-axis direction).

FIG. 5 is a diagram of assistance in explaining the distribution of eddy current loops generated in the layered stator core for use in the axial gap three-phase motor according to the first embodiment of the present invention at flowing electric current to U-phase coils.

FIG. 6 is a diagram of assistance in explaining the distribution of eddy current loops generated in the layered stator core for use in the axial gap three-phase motor according to the first embodiment of the present invention at flowing electric current to V-phase coils.

FIG. 7 is a diagram of assistance in explaining the distribution of eddy current loops generated in the layered stator core for use in the axial gap three-phase motor according to the first embodiment of the present invention at flowing electric current to W-phase coils.

FIG. 8 is a diagram of assistance in explaining the distribution of eddy current loops generated in a layered stator core as a first comparative example.

FIG. 9 is a diagram of assistance in explaining the distribution of eddy current loops generated in a layered stator core as a second comparative example.

FIG. 10 is a block diagram (perspective view) of a layered stator core for use in the axial gap three-phase motor according to a second embodiment of the present invention.

FIG. 11 is a cross-sectional view (perspective view) of the layered stator core illustrated in FIG. 10 taken along the center in the axial direction (y-axis direction).

FIG. 12 is a block diagram (perspective view) of a layered stator core for use in the axial gap three-phase motor according to a third embodiment of the present invention.

FIG. 13 is a diagram of assistance in explaining the holding state of coils wound onto the layered stator core for use in the axial gap three-phase motor according to the third embodiment of the present invention.

FIG. 14 is a perspective view (schematic diagram) of the axial gap three-phase motor according to the third embodiment of the present invention.

FIG. 15 is a cross-sectional view of the axial gap three-phase motor according to the third embodiment of the present invention.

FIG. 16 is a cross-sectional view (perspective view) of the layered stator core for use in the axial gap three-phase motor according to the third embodiment of the present invention of the present invention.

FIG. 17 is a diagram of assistance in explaining a process for producing the layered stator core for use in the axial gap three-phase motor according to the third embodiment of the present invention.

FIG. 18 is a flowchart of a method for producing a stator for use in the axial gap three-phase motor according to the third embodiment of the present invention.

### DESCRIPTION OF EMBODIMENTS

Hereinafter, as an example of a two-rotor-one-stator axial gap polyphase motor according to the present invention, an axial gap three-phase motor will be described. Needless to say, the structures described below can be used for a polyphase motor other than the three-phase motor. In addition, they can be used as an electric generator, not as the motor. The same reference numerals are used for similar portions, and the description is omitted.

### First Embodiment

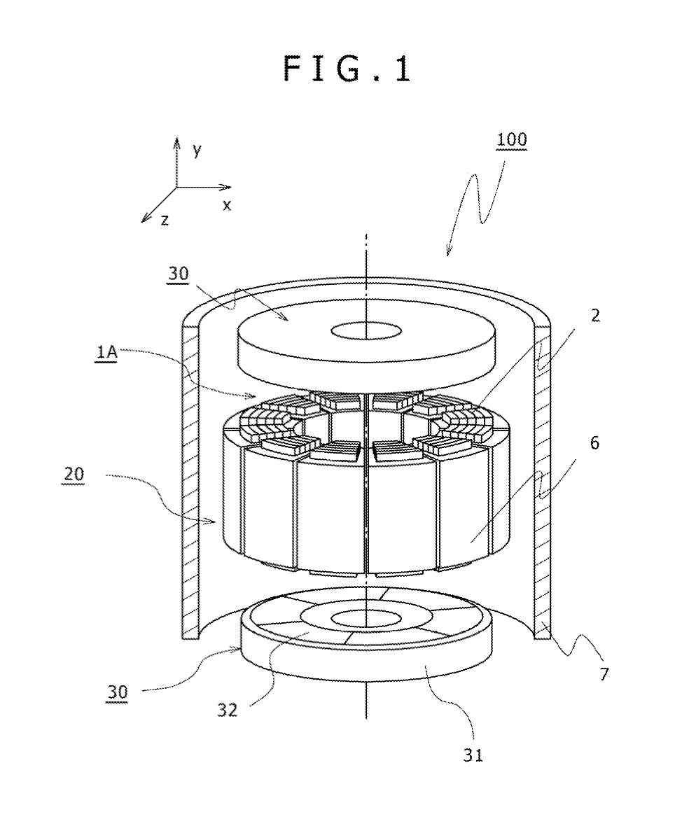

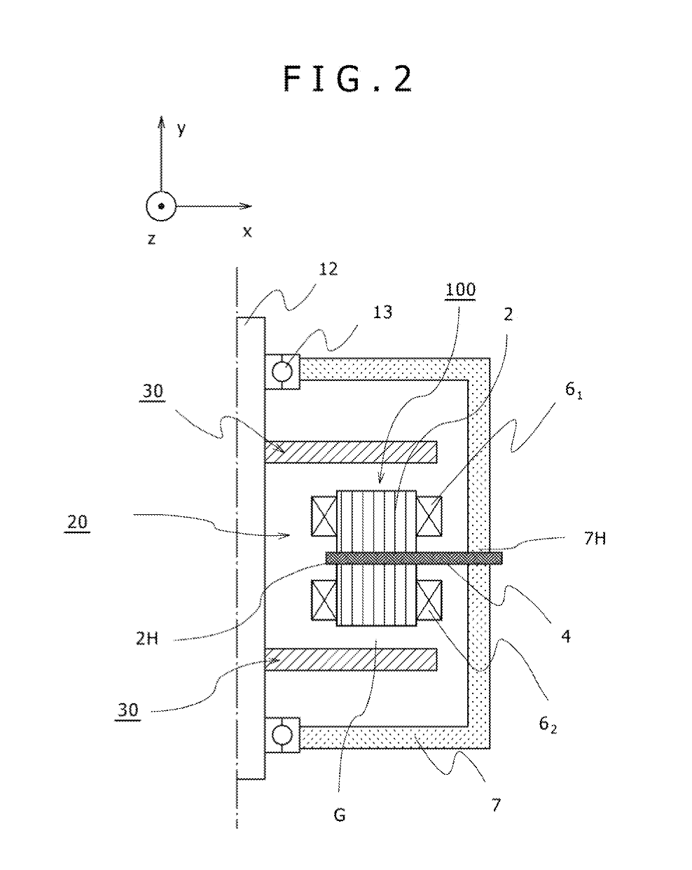

Referring to FIGS. 1 and 2, the structure and operation of an axial gap three-phase motor according to a first embodiment of the present invention will be described below.

Referring to FIG. 1, the entire structure of the axial gap three-phase motor will be described. FIG. 1 is a perspective view (schematic diagram) of an axial gap three-phase motor 100 according to the first embodiment of the present invention.

The axial gap three-phase motor 100 has a cylindrical stator 20, two disc-like rotors 30, and a housing 7.

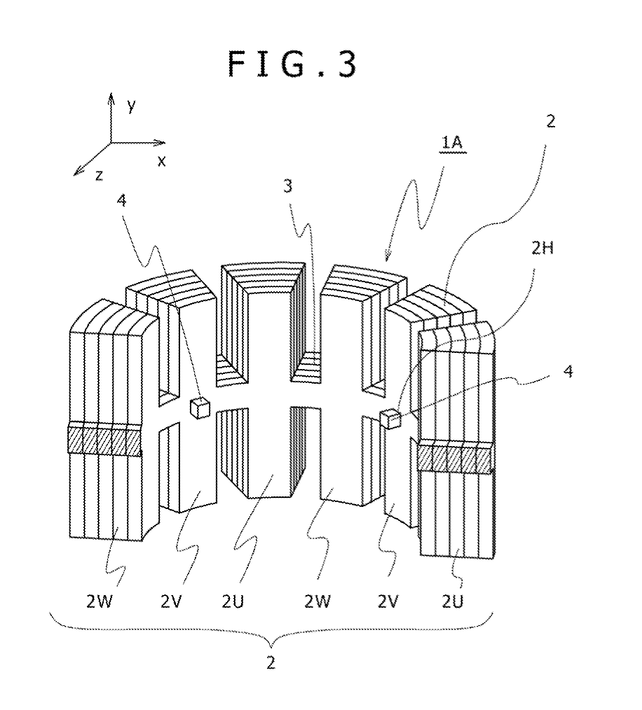

The stator 20 has a layered stator core 1A, and coils 6. In FIG. 1, for simplicity, the coils 6 are schematically illustrated. The layered stator core 1A has twelve core portions (salient poles) 2 protruding in the axial direction of the stator 20. The twelve core portions 2 are arranged at equal spacing in the circumferential direction of the stator 20. The layered stator core 1A will be described later in detail with reference to FIG. 3.

The rotors 30 each have a disc-like structuring member 31, and six permanent magnets 32. In FIG. 1, the permanent magnets 32 are arranged in the structuring member 31 at equal spacing in the circumferential direction. The permanent magnets 32 are of alternately different polarities in the circumferential direction.

The housing 7 houses the staler 20 and the rotors 30. The housing 7 is made of metal, such as die cast aluminum.

Referring to FIG. 2, the structure of the axial gap three-phase motor 100 will be described. FIG. 2 is a cross-sectional view of the axial gap three-phase motor 100 according to the first embodiment of the present invention. FIG. 2 illustrates only the right half of the cross-sectional view in which the axial gap three-phase motor 100 is symmetric with respect to the axis.

The stator 20 has the layered stator core 1A, and the coils 6 (6₁ and 6₂). The layered stator core 1A is formed of an electromagnetic steel plate (silicon steel plate) layered in the radial direction of the stator 20. In place of the electromagnetic steel plate, amorphous material may be used.

The layered stator core 1A has the core portions 2 protruding to both sides in the axial direction of the stator 20, and bar-like fastening members 4. The fastening members 4 are made of conductive material, such as SUS (stainless steel) and SCM (chromium-molybdenum steel).

The coils 6₁ are wound onto the outer periphery on the upper side of the core portions 2, and the coils 6₂ are wound onto the outer periphery on the lower side of the core portions 2. The coils 6₁ and 6₂ are wound so that magnetic fields generated in the axial direction (the y-axis direction) of the core portions 2 have the same direction.

The fastening members 4 are inserted into apertures 2H provided in the corresponding core portions 2 at the center in the axial direction (the y-axis direction) and in the radial direction. One end of each fastening member 4 is fastened and fixed to the layered stator core 1A. In addition, the fastening members 4 are inserted into apertures 7H provided in the housing 7. The other end of each fastening member 4 is fastened and fixed to the housing 7. With this, the stator 20 is fixed to the housing 7.

The pair of rotors 30 is fixed to a shaft 12 at fixed spacing in the axial direction (the y-axis direction) thereof. The shaft 12 is rotatably supported by bearings 13 provided in the housing 7.

Here, the stator 20 is sandwiched between the pair of rotors 30. Air gap G is formed between the stator 20 and each rotor 30. With this, the stator 20 and the rotor 30 are arranged on the same axis across air gap G.

Referring to FIGS. 1 and 2, the operation of the axial gap three-phase motor 100 will be described.

When electric current flows to the coils 6, the stator 20 generates magnetic fields in the axial direction (the y-axis direction) of the shaft 12. The permanent magnets 32 of the rotors 30 also generate magnetic fields in the axial direction of the shaft 12. The electric current flowing to the coils 6 is controlled so that the magnetic fields generated by the stator 20 and the rotors 30 interact to rotate the rotors 30.

Referring to FIG. 3, the structure of the layered stator core 1A for use in the axial gap three-phase motor 100 according to the first embodiment of the present invention will be described. FIG. 3 is a block diagram (perspective view) of the layered stator core 1A for use in the axial gap three-phase motor 100 according to the first embodiment of the present invention. In FIG. 3, for simplicity, the coils 6 are not illustrated.

The layered stator core 1A has the core portions 2 onto which the coils 6 are wound, supporting portions 3 connecting and supporting the adjacent core portions 2, and the fastening members 4 made of conductive material.

In this embodiment, one electromagnetic steel plate (magnetic thin plate) is punched and taken up, so that the supporting portions 3 continuous in the circumferential direction and the core portions 2 protruding in the axial direction are spirally integrally formed in the layered stator core 1A.

The core portions 2 protrude to both sides (the + and −directions) in the axial direction (the y-axis direction) of the layered stator core 1A. The core portions 2 have, with respect to three-phase alternating current (U, V, W) driving the motor, U-phase core portions 2U onto which the U-phase coils 6 are wound, V-phase core portions 2V onto which the V-phase coils 6 are wound, and W-phase core portions 2W onto which the W-phase coils 6 are wound. Each U-phase core portion 2U, each V-phase core portion 2V, and each W-phase core portion 2W are arranged in that order at equal spacing in the circumferential direction of the layered stator core 1A.

The fastening members 4 are inserted into the apertures 2H provided in the corresponding core portions 2 at the center in the axial direction (y-axis direction) and in the radial direction, and then fasten the electromagnetic steel plate forming the layered stator core 1A. In FIG. 3, the fastening members 4 continuous in the radial direction are inserted only into the V-phase core portions 2V onto which the V-phase coils 6 are wound. This can prevent the layered stator core 1A from shifting out of position.

Here, as illustrated in FIG. 3, the supporting portions 3 and the apertures 2H pass through the center in the axial direction of the corresponding core portions 2, and are arranged on a plane perpendicular to the axis of the layered stator core 1A. That is, the supporting portions 3 and the apertures 2H are located in the same position in the y-axis direction (or at the same y-coordinate). The layered stator core 1A is symmetric with respect to the plane. The weight balance of the stator 20 can thus be improved.

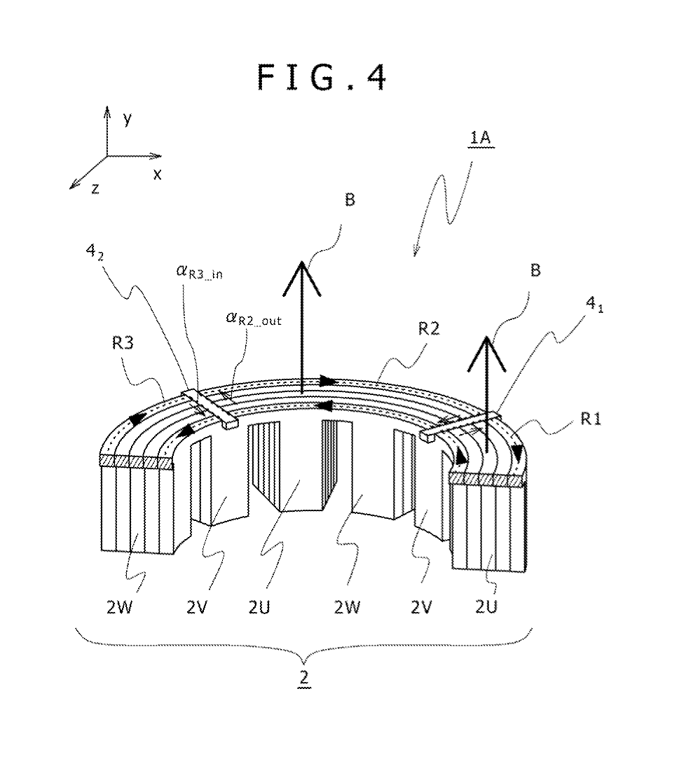

Referring to FIG. 4, eddy current loops generated in the layered stator core 1A will be described.

FIG. 4 is a cross-sectional view (perspective view) of the layered stator core 1A illustrated in FIG. 3 taken along the center in the axial direction (the y-axis direction).

In the layered stator core 1A, the fastening members 4 continuous in the radial direction are inserted only into the V-phase core portions 2V onto which the V-phase coils 6 are wound. When electric current flows to the coils 6 of one of the three phases (U, V, W), eddy current loops R1, R2, and R3 are formed, as illustrated in FIG. 4.

For instance, it is assumed that when electric current flows to the U-phase coils 6, magnetic fields B are generated in the y-axis direction (+) in the U-phase core portions 2U. In this case, the eddy current loops R1, R2, and R3 are formed so that generated magnetic fields B cancel each other out.

Here, in the fastening members 4 (4₁ and 4₂), the eddy currents are opposite in direction, and cancel each other out. For instance, in the fastening member 4₂, eddy currents α_{R3}_{_{—}}ᵢₙ and α_{R2}_{_{—}}ₒᵤₜ are opposite in direction, and cancel each other out.

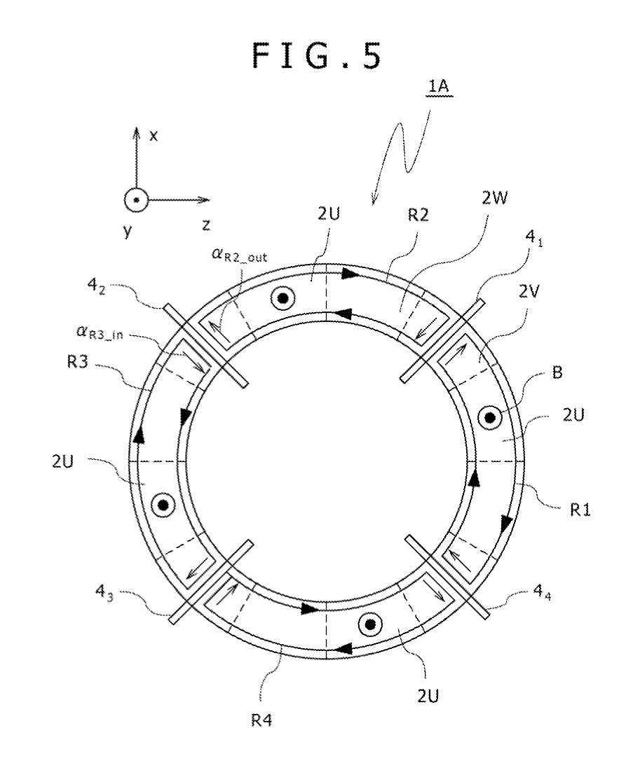

Referring to FIGS. 5 to 9, eddy current loops generated in the layered stator core 1A for use in the axial gap three-phase motor 100 according to the first embodiment of the present invention will be compared with other examples. Hereinafter, it is assumed that magnetic fields B are generated in the y-axis direction (+) in the U-phase core portions 2U.

Referring to FIG. 5, the distribution of eddy current loops generated in the layered stator core 1A for use in the axial gap three-phase motor 100 according to the first embodiment of the present invention will be described.

FIG. 5 is a diagram of assistance in explaining the distribution of the eddy current loops generated in the layered stator core 1A for use in the axial gap three-phase motor 100 according to the first embodiment of the present invention at flowing electric current to the U-phase coils. FIG. 5 is a cross-sectional view of the layered stator core 1A provided with the fastening members 4 only in the V-phase core portions 2V taken along the center in the axial direction (the y-axis direction).

In this case, four eddy current loops R1 to R4 are formed. As described above, in the fastening members 4 (4₁ to 4₄) arranged in the V-phase core portions 2V, the eddy currents cancel each other out.

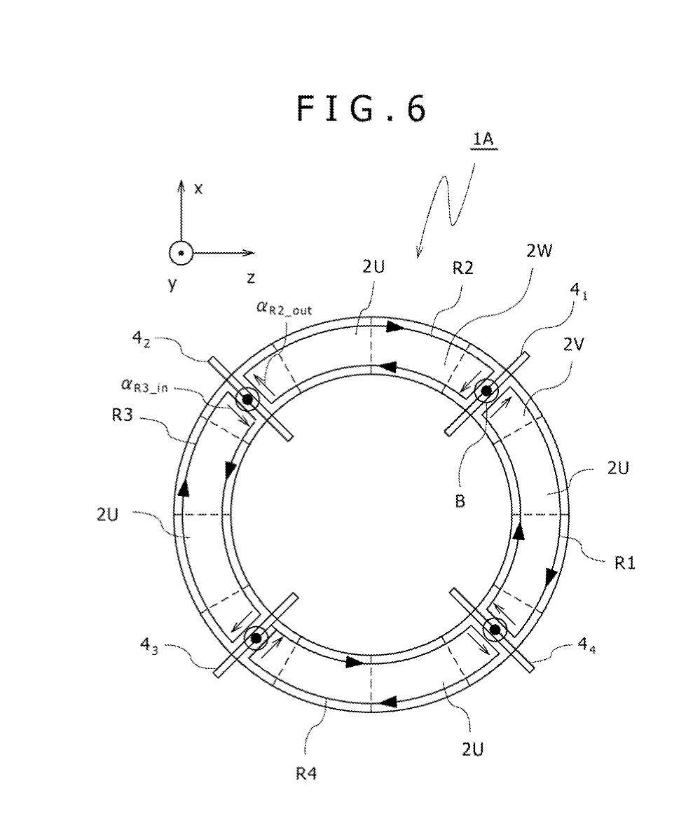

Referring to FIG. 6, the distribution of eddy current loops generated in the layered stator core 1A at flowing electric current to the V-phase coils 6 will be described.

FIG. 6 is a diagram of assistance in explaining the distribution of the eddy current loops generated in the layered stator core 1A for use in the axial gap three-phase motor 100 according to the first embodiment of the present invention at flowing electric currents to the V-phase coils.

The positions where magnetic fields B are generated in FIG. 6 are different from those in FIG. 5. In this example, the electric current flows to the V-phase coils 6. Magnetic fields B are thus generated in the V-phase core portions 2V.

In this case, four eddy current loops R1 to R4 are formed. Like FIG. 5, in the fastening members 4 (4₁ to 4₄) arranged in the V-phase core portions 2V, the eddy currents cancel each other out.

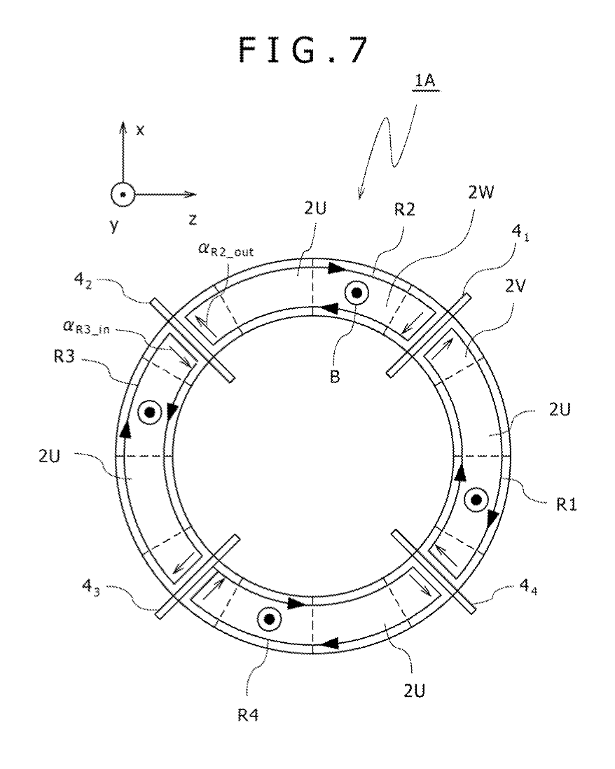

Referring to FIG. 7, the distribution of eddy current loops generated in the layered stator core 1A at flowing electric current to the W-phase coils 6 will be described.

FIG. 7 is a diagram of assistance in explaining the distribution of the eddy current loops generated in the layered stator core 1A for use in the axial gap three-phase motor 100 according to the first embodiment of the present invention at flowing electric current to the W-phase coils.

The positions where magnetic fields B are generated in FIG. 7 are different from those in FIG. 5. In this example, the electric current flows to the W-phase coils 6. Magnetic fields B are thus generated in the W-phase core portions 2W.

In this case, four eddy current loops R1 to R4 are formed. Like FIG. 5, in the fastening members 4 (4₁ to 4₄) arranged in the V-phase core portions 2V, the eddy currents cancel each other out.

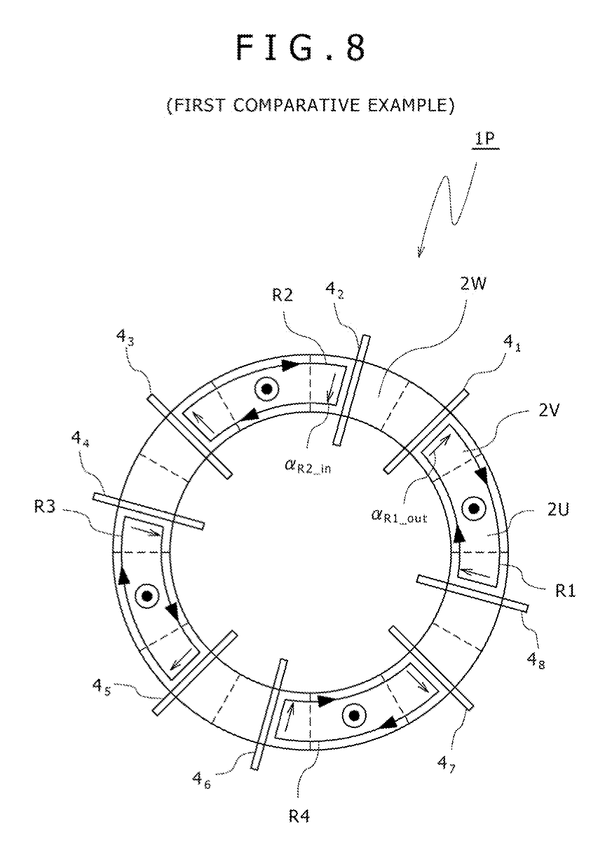

Referring to FIG. 8, the distribution of eddy current loops of a first comparative example will be described. FIG. 8 is a diagram of assistance in explaining the distribution of the eddy current loops generated in a layered stator core 1P as the first comparative example. FIG. 8 is a cross-sectional view of the layered stator core 1P provided with the fastening members 4 in the V-phase core portions 2V and the W-phase core portions 2W taken along the center in the axial direction (the y-axis direction).

In this case, four eddy current loops R1 to R4 are formed. There are no pairs of adjacent eddy currents in the fastening members 4 (4₁ to 4₈) arranged in the V-phase core portions 2V and the W-phase core portions 2W. Consequently, no eddy currents cancelling-out occurs. For instance, there is no eddy current adjacent to eddy current α_{R1}_{_{—}}ₒᵤₜ in the fastening member 4₁, so that no cancelling-out occurs with respect to eddy current α_{R1}_{_{—}}ₒᵤₜ. Likewise, no cancelling-out occurs with respect to eddy current α_{R2}_{_{—}}ᵢₙ in the fastening member 4₂.

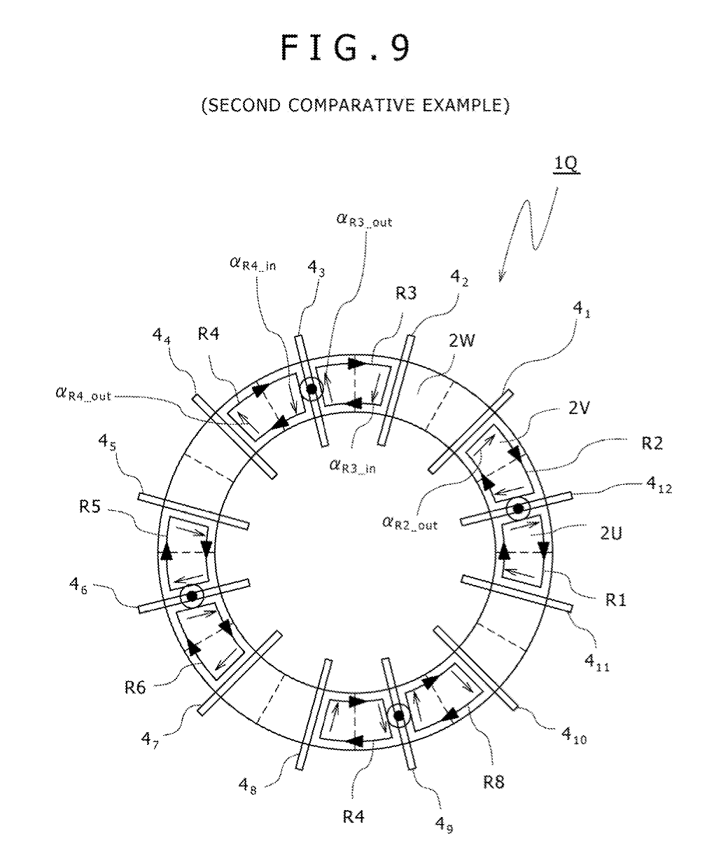

Referring to FIG. 9, the distribution of eddy current loops of a second comparative example will be described. FIG. 9 is a diagram of assistance in explaining the distribution of the eddy current loops generated in a layered stator core 1Q as the second comparative example. FIG. 9 is a cross-sectional view of the layered stator core 1Q provided with the fastening members 4 (4₁ to 4₁₂) in all the core portions 2U, 2Y, and 2W taken along the center in the axial direction (the y-axis direction).

In this case, eight eddy current loops R1 to R3 are formed. Here, the adjacent eddy currents are opposite in direction in the fastening members 4 arranged in the U-phase core portions 2U, so that the eddy currents cancel each other out. For instance, eddy currents α_{R4}_{_{—}}ᵢₙ and α_{R3}_{_{—}}ₒᵤₜ are opposite in direction in the fastening member 4₃, and cancel each other out.

There are no pairs of adjacent eddy current loops in the fastening members 4 arranged in the V-phase core portions 2V and the W-phase core portions 2W. Consequently, no eddy current loops cancelling-out occurs. For instance, there is no eddy current adjacent to eddy current α_{R2}_{_{—}}ₒᵤₜ in the fastening member 4₁, so that no cancelling-out occurs with respect to eddy current α_{P2}_{_{—}}ₒᵤₜ. In addition, there is no eddy current adjacent to eddy current α_{R3}_{_{—}}ᵢₙ the fastening member 4₂, so that no cancelling-out occurs with respect to eddy current α_{R3}_{_{—}}ᵢₙ. Likewise, no cancelling-out occurs with respect to eddy current α_{R4}_{_{—}}ₒᵤₜ in the fastening member 4₄.

As described above, in this embodiment, the fastening members 4 continuous in the radial direction are inserted only into the V-phase core portions 2V onto which the V-phase coils 6 are wound. With this, losses caused by the eddy currents generated in the layered stator core can be eliminated, while the layered stator core can be prevented from shifting out of position.

In this embodiment, the fastening members 4 are arranged only in the V-phase core portions 2V. However, the same effect can be obtained when the fastening members 4 are arranged only in the U-phase core portions 2U or only in the W-phase core portions 2W. In addition, in the case of an N-phase motor (N≧2), the same effect can be obtained by arranging the fastening members 4 only in the core portions 2 of a particular one phase.

### Second Embodiment 1

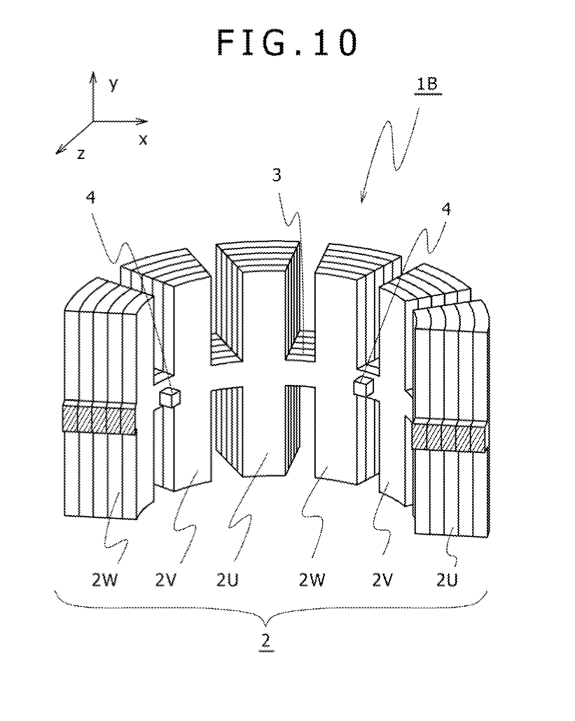

Referring to FIG. 10, the structure of a layered stator core 1B for use in the axial gap three-phase motor 100 according to a second embodiment of the present invention will be described. FIG. 10 is a block diagram (perspective view) of the layered stator core 1B for use in the axial gap three-phase motor 100 according to the second embodiment of the present invention. In FIG. 10, for simplicity, the coils 6 are not illustrated.

The layered stator core 1B of this embodiment is the same as the layered stator core 1A in FIG. 3 except that the positions of the fastening members 4 are different. Specifically, the fastening members 4 continuous in the radial direction are inserted only into the supporting portions 3 between the V-phase core portions 2V and the W-phase core portions 2W. This can prevent the layered stator core 1B from shifting out of position.

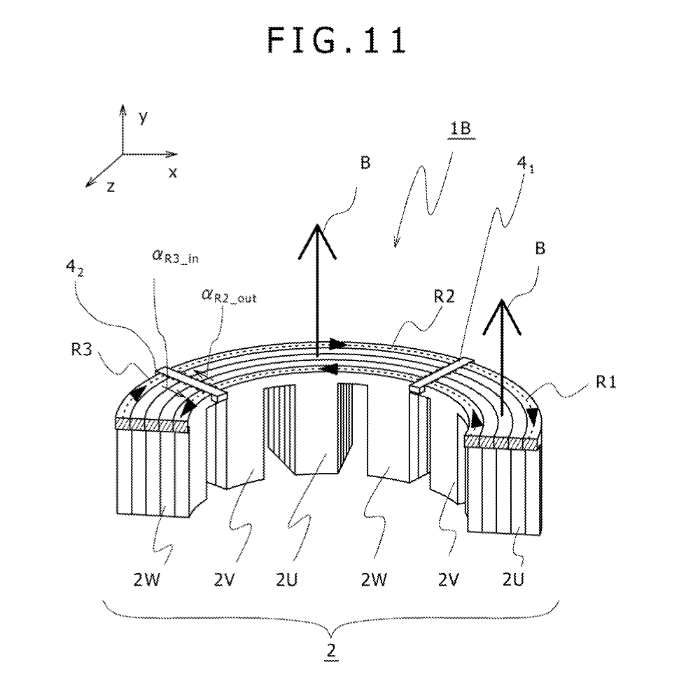

Referring to FIG. 11, the distribution of eddy current loops generated in the layered stator core 1B will be described. FIG. 11 is a cross-sectional view (perspective view) of the layered stator core 1B illustrated in FIG. 10 taken along the center in the axial direction (the y-axis direction).

When electric current flows to the coils 6 of one of the three phases (U, V, W), eddy current loops R1, R2, and R3 are formed, as illustrated in FIG. 9.

It is assumed that when the electric current flows to the U-phase coils 6, magnetic fields B are generated in the y-axis direction (+) in the U-phase core portions 2U. In this case, the eddy current loops R1, R2, and R3 are formed so that generated magnetic fields B cancel each other out. Like the first embodiment, when the electric current flows to the V-phase core portions 2V or the W-phase core portions 2W, the eddy current loops R1, R2, and R3 are also formed, as illustrated in FIG. 11.

Here, the adjacent eddy currents are opposite in direction in the fastening members 4 (4₁ and 4₂), and cancel each other out. This can eliminate the eddy currents generated in the layered stator core 1B. Losses caused by the eddy currents can be eliminated.

As described above, according to this embodiment, losses caused by the eddy currents generated in the layered stator core can be eliminated, while the layered stator core can be prevented from shifting out of position.

In this embodiment, the fastening members 4 are arranged only in the supporting portions 3 between the V-phase core portions 2V and the W-phase core portions 2W. However, the same effect can be obtained when the fastening members 4 are arranged only in the supporting portions 3 between the U-phase core portions 2U and the V-phase core portions 2V or are arranged only in the supporting portions 3 between the U-phase core portions 2U and the W-phase core portions 2W. In addition, in the case of an N-phase motor (N≧2), the same effect can be obtained by arranging the fastening members 4 only in the supporting portions 3 between the particular phases.

### Third Embodiment

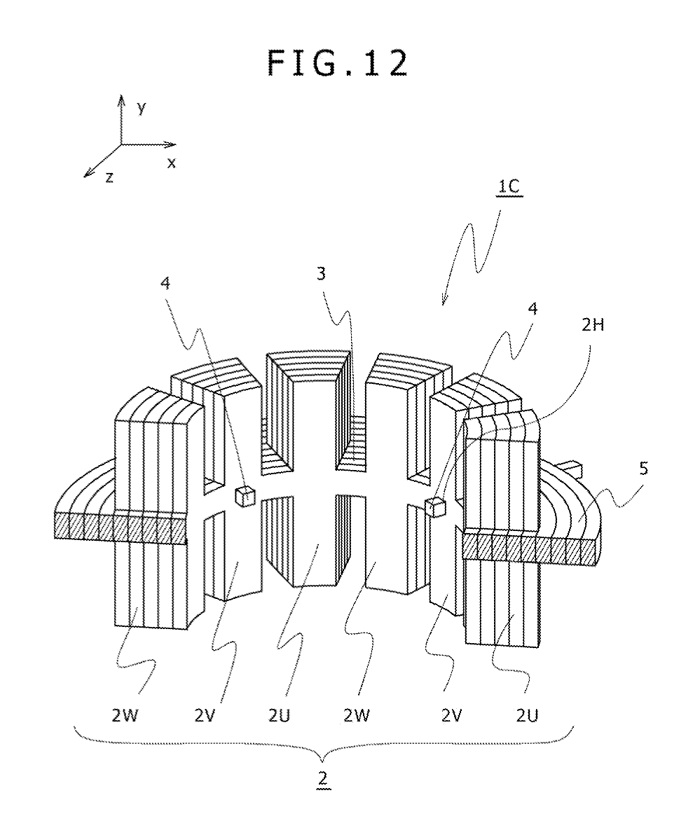

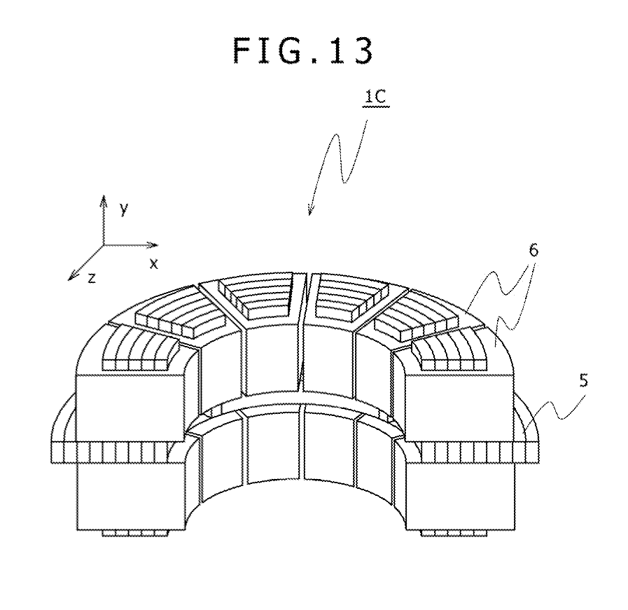

Referring to FIGS. 12 and 13, the structure of a layered stator core 1C for use in the axial gap three-phase motor 100 according to a third embodiment of the present invention will be described.

Referring to FIG. 12, the structure of the layered stator core 1C will be described. FIG. 12 is a block diagram (perspective view) of the layered stator core 1C for use in the axial gap three-phase motor 100 according to the third embodiment of the present invention. In FIG. 12, for simplicity, the coils 6 are not illustrated.

Unlike the layered stator core 1A in FIG. 3, the layered stator core 1C of this embodiment is provided with a support link (annular portion) 5.

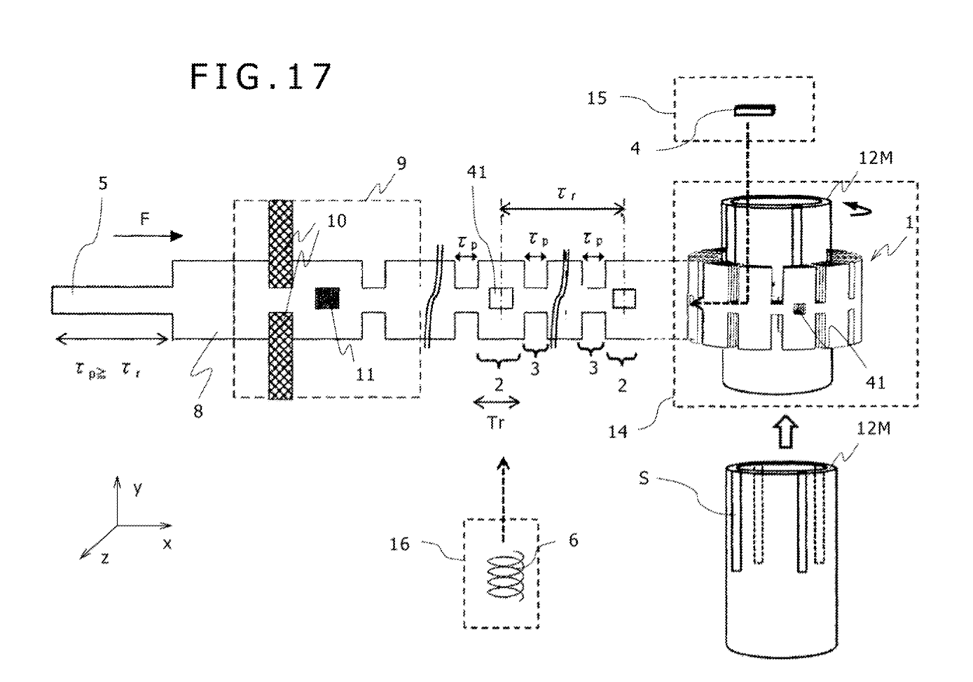

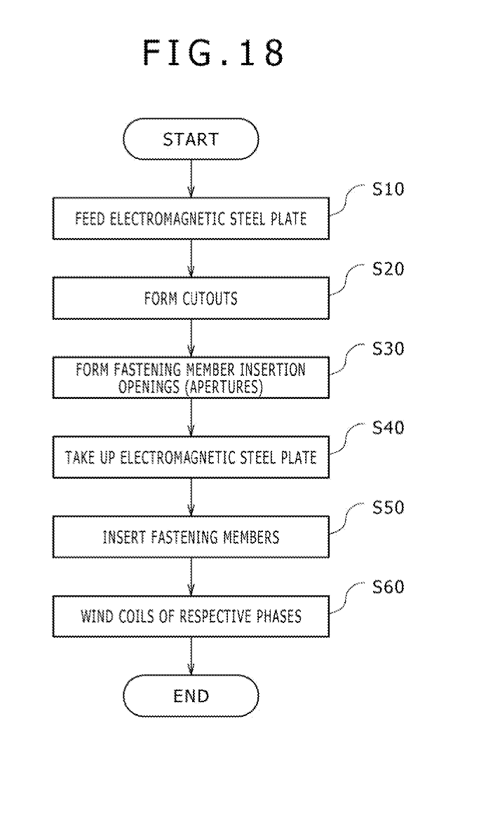

In this embodiment, one electromagnetic steel plate is punched and taken up, so that the core portions 2, the supporting portions 3, and the support link 5 are spirally integrally formed in the layered stator core 1C. A method for producing the layered stator core 1C will be described later in detail with reference to FIGS. 17 and 18.

The support link 5 has apertures communicating with the apertures 2H provided in the core portions 2. The fastening members 4 are inserted and penetrated through these apertures.

The layered stator core 1 and the support link 5 are integrally fastened by the fastening members 4. According to this embodiment, by arranging the support link 5, the layered stator core 1 can be prevented from being loosened. The strength in the radial and circumferential directions can thus be improved.

Referring to FIG. 13, the holding state of the coils 6 wound onto the layered stator core 1C will be described. FIG. 13 is a diagram of assistance in explaining the holding state of the coils 6 wound onto the layered stator core 1C for use in the axial gap three-phase motor 100 according to the third embodiment of the present invention. In FIG. 13, for simplicity, the coils 6 are schematically illustrated.

The support link 5 holds the coils 6 wound onto the core portions 2 of the layered stator core 1. This can improve the positioning accuracy in the axial direction of the coils 6.

In this embodiment, the support link 5 is arranged on the outer circumference of the layered stator core 1. However, the support link 5 may be arranged on the inner circumference of the layered stator core 1.

In addition, the support link 5 is not limited to the layered body, and may have an integrally formed ring-like member.

Further, the support link 5 may be added to the structure of the second embodiment.

### APPLICATION EXAMPLES

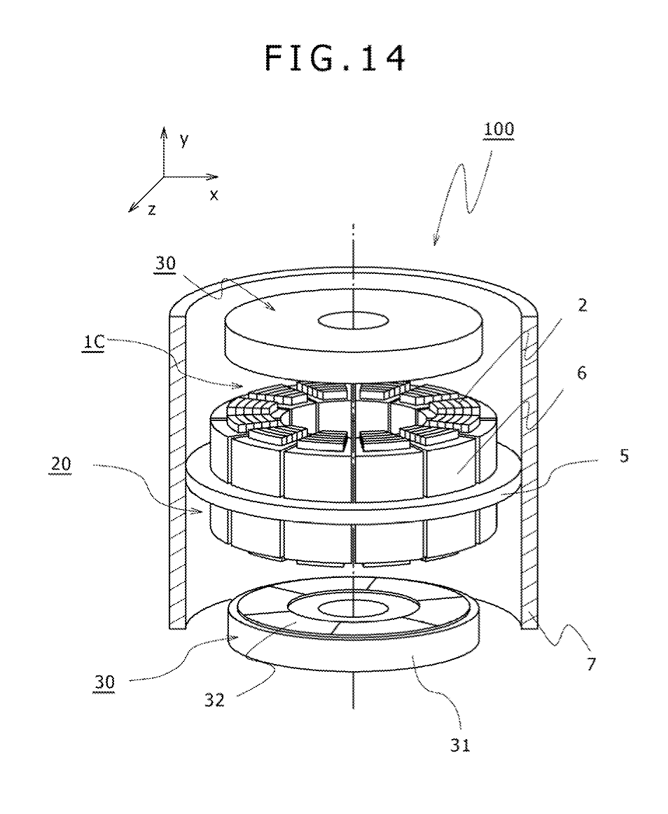

Referring to FIGS. 14 to 16, the structures of the axial gap three-phase motor 100 according to the third embodiment using the layered stator core 1C will be described.

Referring to FIG. 14, the structure of the axial gap three-phase motor 100 according to the third embodiment of the present invention will be described. FIG. 14 is a perspective view (schematic diagram) of the axial gap three-phase motor 100 according to the third embodiment of the present invention.

The annular support link 5 is fixed to the housing 7 by shrink fitting. With this, the outer end face of the annular support link 5 in the radial direction is securely fixed to the inner circumferential surface of the housing 7.

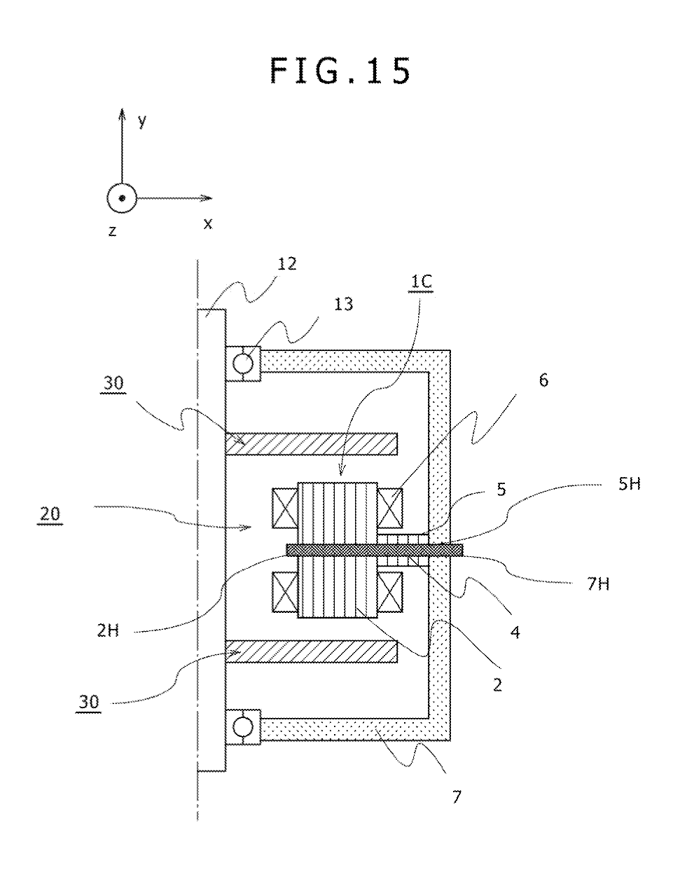

Referring to FIG. 15, the structure of the axial gap three-phase motor 100 according to the third embodiment of the present invention will be described. FIG. 15 is a cross-sectional view of the axial gap three-phase motor 100 according to the third embodiment of the present invention.

The housing 7 has the apertures 7H in the radial direction communicating with the apertures 2H provided in the layered stator core 1C and apertures 5H provided in the support link 5.

The fastening members 4 are inserted and penetrated through the apertures 2H in the layered stator core 1C, the apertures 5H in the support link 5, and the apertures 7H in the housing 7. The layered stator core 1C, the support link 5, and the housing 7 are integrally fastened by the fastening members 4. With this, the stator 20 of the axial gap three-phase motor 100 can be fixed to the housing 7 without using resin mold material.

In addition, the fastening members 4 are made of conductive material. The fastening members 4 thus allow the layered stator core 1 and the support link 5 to be electrically conductive in the radial direction. With this, the layered stator core 1 and the support link 5 are grounded to the housing 7. They can thus be prevented from being at a floating potential.

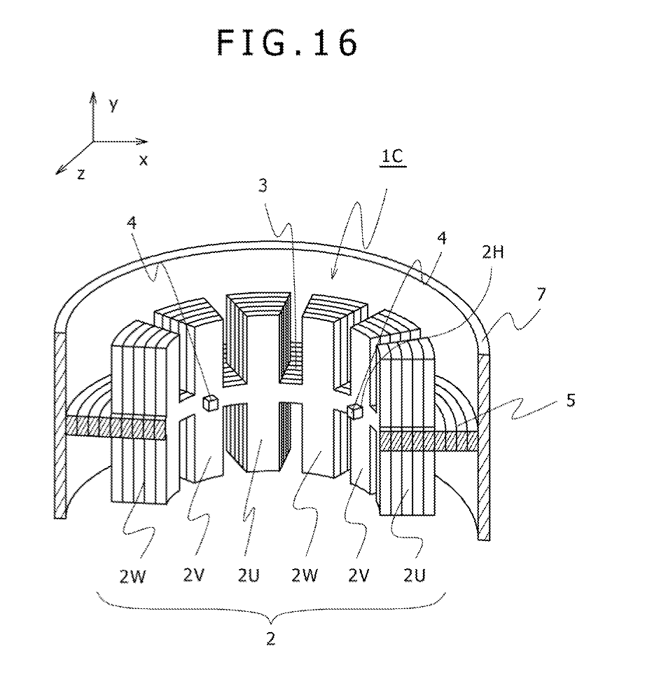

Referring to FIG. 16, the structure of the layered stator core 1C will be described. FIG. 16 is a cross-sectional view (perspective view) of the layered stator core 1C for use in the axial gap three-phase motor 100 according to the third embodiment of the present invention.

In FIG. 16, the fastening members 4 continuous in the radial direction are inserted only into the V-phase core portions 2V onto which the V-phase coils 6 are wound. With this, losses caused by the eddy currents generated in the layered stator core can be eliminated, while the layered stator core can be prevented from shifting out of position.

A method for Producing the Stator

A method for producing the stator 20 for use in the axial gap three-phase motor 100 according to the third embodiment of the present invention will be described. The method for producing the stator 20 includes a process for producing the layered stator core 1C and a process for winding the coils. The processes will be described below in detail.

(1) The Process for Producing the Layered Stator Core

Referring to FIG. 17, the process for producing the layered stator core 1C will be described. FIG. 17 is a diagram of assistance in explaining the process for producing the layered stator core 1C for use in the axial gap three-phase motor according to the third embodiment of the present invention.

An electromagnetic steel plate (magnetic thin plate) 8 is conveyed, by feeding amount F, to a punching machine 9. The punching machine 9 has punching units 10 for punching, into width τp, both ends of the electromagnetic steel plate 8 in the y-axis direction, and a punching unit 11 for punching, into pitch τr, fastening member insertion openings (apertures) 41 for inserting the fastening members 4 thereinto.

Here, pitch tr is preferably increased toward the outer circumference. For that, feeding amount F is increased. Pitch tp is small, so that the necessity for increasing it toward the outer circumference is less than tr. In this embodiment, tp is constant.

The electromagnetic steel plate 8 processed by the punching machine 9 is formed into the layered stator core 1C while being wound by a cylindrical shaft 12M of a takeup device 14.

Here, the cylindrical shaft 12M has four slits S in the axial direction (the y-axis direction). In FIG. 17, the slits M are provided at one end in the axial direction of the cylindrical shaft 12M. The silts S are equal in number to that of the fastening members 4.

In this embodiment, when the takeup device 14 takes up the layered stator core 1C onto the shaft 12M, an inserting device 15 pushes out the fastening members 4 from the inner circumferential side of the layered stator core 1C through the slits S to the outer circumferential side thereof whenever necessary. This can improve the positioning accuracy and the holding strength of the layered stator core 1C.

In addition, the width in the circumferential direction of the supporting portions 3 of the layered stator core 1C is constant at τp. It is thus unnecessary to vary the tooth width of the punching units 10, thereby reducing the producing cost.

Further, width Tr of the core portions 2 of the layered stator core 1C is increased toward the outer circumference. However, by increasing feeding amount F appropriately, the layered stator core 1C with a minimum number of components can be produced.

For the support link 5, the layered stator core 1C can be produced in such a manner that the punching machine 9 controls feeding amount F so that it is τp≧τr.

In this embodiment, width τp of the cutouts is constant. However, width to may be increased toward the outer circumference. Such cutouts are overlapped in the x-axis direction by reducing feeding amount F.

(2) The Process for Winding the Coils

As illustrated in FIG. 12, the produced layered stator core 1C has the U-phase core portions 2U onto which the U-phase coils 6 are wound, the V-phase core portions 2V onto which the V-phase coils 6 are wound, and the W-phase core portions 2W onto which the W-phase coils 6 are wound. A winding device 16 winds the coils 6 of the respective phases onto the core portions 2.

As illustrated in FIG. 12, the produced layered stator core 1C has the support link 5. This can improve the positioning accuracy in the axial direction of the coils 6 being wound.

Referring to FIG. 18, a method for producing the stator 20 for use in the axial gap three-phase motor according to the third embodiment of the present invention will be described. FIG. 18 is a flowchart of the method for producing the stator 20 for use in the axial gap three-phase motor according to the third embodiment of the present invention.

As illustrated in FIG. 17, the punching machine 9 feeds the magnetic steel plate 8 extending in a belt shape, in the longer side direction (the x-axis direction) (step S10). The punching machine 9 forms cutouts at both ends of the magnetic steel plate 8 in the shorter side direction (the y-axis direction) and at predetermined spacing in the longer side direction (step S20). This forms the core portions 2 between the cutouts adjacent in the longer side direction, and the supporting portions 3 between the cutouts adjacent in the shorter side direction.

The punching machine 9 forms the fastening member insertion openings (apertures) 41 only in the core portions 2 onto which are wound the coils 6 for flow of electric current of one of the three phases or the supporting portions 3 connecting and supporting the core portions 2 and the next core portions 2 onto which are wound the coils 6 for flow of electric current of the next phase (step S30).

The takeup device 14 takes up the electromagnetic steel plate 8 onto the shaft 12M so as to penetrate the fastening member insertion openings 41 therethrough in the radial direction (step S40).

The inserting device 15 inserts the fastening members 4 into the fastening member insertion openings 41 in the radial direction while the magnetic steel plate 8 is taken up (step S50).

Finally, the winding device 16 winds the coils 6 of the respective phases onto the U-phase core portions 2U, the V-phase core portions 2V, and the W-phase core portions 2W (step S60).

Here, in step S20, the support link may be formed by controlling feeding amount F of the magnetic steel plate 8 so that it is smaller than width τp of the cutouts. Thereby, the layered stator core 1 is integrally formed with the support link 5.

As described above, according to the producing method of this embodiment, the producing cost of the stator 20 can be reduced.

The present invention is not limited to the above embodiments, and includes various modifications. For instance, the above embodiments have been described in detail to easily understand the present invention, and are not always limited to include all the described structures. Part of the structure of one embodiment can be replaced with the structures of other embodiments. To the structure of one embodiment, the structures of other embodiments can be added. Part of the structure of each embodiment can be subject to addition, deletion, and replacement with other structures.

### LIST OF REFERENCE SIGNS

1 . . . Layered stator core
2 . . . Core portion (salient pole)
2H . . . Aperture
2U . . . U-phase core portion
2Y . . . V-phase core portion
2W . . . W-phase core portion
3 . . . Supporting portion
4 . . . Fastening member
41 . . . Fastening member insertion opening (aperture)
5 . . . Support link (annular portion)
5H . . . Aperture
6 . . . Coil
7 . . . Housing
H . . . Aperture
8 . . . Electromagnetic steel plate (magnetic thin plate)
9 . . . Punching machine
11 . . . Punching unit
12 . . . Shaft
12M . . . Takeup shaft
S . . . Slit
13 . . . Bearing
14 . . . Takeup device
15 . . . Inserting device
16 . . . Winding device
20 . . . Stator
30 . . . Rotor
31 . . . Permanent magnet
32 . . . Structuring member
100 . . . Axial gap three-phase motor

1. An axial gap polyphase motor comprising:
a stator; and
a rotor arranged on the same axis as the stator across a gap,
the stator including:
a layered stator core having a plurality of core portions arranged at equal spacing in the circumferential direction and protruding in the axial direction, and a plurality of supporting portions connecting and supporting the adjacent core portions;
coils wound onto the core portions; and
fastening members made of conductive material,
wherein only the core portions onto which are wound the coils for flow of electric current of a single phase from among the multiple phases or the supporting portions connecting and supporting the core portions and the next core portions onto which are wound the coils for flow of electric current of the next phase have first apertures in the radial direction,
wherein the fastening members are inserted into the first apertures.

2. The axial gap polyphase motor according to claim 1, wherein the supporting portions and the first apertures are arranged on a plane perpendicular to the axis of the stator.

3. The axial gap polyphase motor according to claim 2, wherein the supporting portions and the first apertures are arranged on the plane passing through the centers in the axial direction of the core portions.

4. The axial gap polyphase motor according to claim 2,
wherein the stator has an annular portion arranged on the outer circumference of the layered stator core,
wherein the annular portion has second apertures communicating with the first apertures,
wherein the fastening members are inserted into the first apertures and the second apertures communicating with the first apertures.

5. The axial gap polyphase motor according to claim 4,
wherein the layered stator core is integrally formed with the annular portion by punching and taking up a magnetic thin plate.

6. A stator for use in an axial gap polyphase motor comprising:
a layered stator core having a plurality of core portions arranged at equal spacing in the circumferential direction and protruding in the axial direction, and a plurality of supporting portions connecting and supporting the adjacent core portions;
coils wound onto the core portions; and
fastening members made of conductive material,
wherein only the core portions onto which are wound the coils for flow of electric current of a single phase from among the multiple phases or the supporting portions connecting and supporting the core portions and the next core portions onto which are wound the coils for flow of electric current of the next phase have first apertures in the radial direction,
wherein the fastening members are inserted into the first apertures.

7. A method for producing a stator comprising:
feeding a magnetic thin plate extending in a belt shape, in the longer side direction;
forming cutouts at both ends of the magnetic thin plate in the shorter side direction and at predetermined spacing in the longer side direction, core portions between the cutouts adjacent in the longer side direction, and supporting portions between the cutouts adjacent in the shorter side direction;
forming first apertures only in the core portions onto which are wound coils for flow of electric current of a single phase from among the multiple phases or the supporting portions connecting and supporting the core portions and the next core portions onto which are wound the coils for flow of electric current of the next phase;
taking up the magnetic thin plate so as to penetrate the first apertures therethrough in the radial direction;
inserting fastening members into the first apertures in the radial direction while the magnetic thin plate is taken up; and
winding the coils for flow of electric current of the respective phases onto the core portions.

8. The method according to claim 7, further comprising forming a belt-shaped portion by controlling the feeding amount of the magnetic thin plate so that the feeding amount of the magnetic thin plate is smaller than width τp of the cutouts.
